(19) United States
(12) Patent Application Publication
(10) Pub. No.: US 2026/0168293 A1
(43) Pub. Date: Jun. 18, 2026

(54) MOTOR VEHICLE LOCKING DEVICE

(71) Applicant: KIEKERT AKTIENGESELLSCHAFT, Heiligenhaus (DE)

(72) Inventors: Tobias STEFFEN, Essen (DE); Murat ÖZDOGAN, Wuppertal (DE); Armin HANDKE, Duisburg (DE)

(73) Assignee: KIEKERT AKTIENGESELLSCHAFT, Heiligenhaus (DE)

(21) Appl. No.: 18/715,987

(22) PCT Filed: Dec. 1, 2022
(86) PCT No.: PCT/EP2022/084036

§ 371 Date: Jun. 3, 2024

(30) Foreign Application Priority Data
Dec. 15, 2021 (DE) 10 2021 133 205.2

(51) Int. Cl. E05B 81/06; E05B 81/16

(52) U.S. Cl. CPC E05B 81/06; E05B 81/16

(57) ABSTRACT

A motor vehicle locking device which is equipped with a coupling arrangement consisting essentially of an actuating lever and a release lever that can be coupled releasably thereto. The actuating lever and the release lever can be coupled to one another starting from an uncoupled basic position by a two-stroke actuation of the actuating lever. An accumulator lever storing the first stroke of the actuating lever is additionally provided so that, during its second stroke, the actuating lever can act upon the release lever after the accumulation lever. According to the invention, an electric motor drive is additionally provided, which optionally prevents or permits a subsequent movement of the release lever during the second stroke of the actuating lever.

### DESCRIPTION

The invention relates to a motor vehicle locking device having a coupling arrangement consisting essentially of an actuating lever and a release lever that can be releasably coupled thereto, wherein the actuating lever and the release lever can be coupled to one another starting from a uncoupled basic position by a two-stroke actuation of the actuating lever, and wherein a accumulator lever is provided which stores the first stroke of the actuating lever so that, during its second stroke, the actuating lever can act on the release lever after the accumulator lever.

Motor vehicle locking devices with the above-described coupling arrangement are often a component of an internal actuating lever chain of a motor vehicle lock and, in particular, a motor vehicle door lock. The known coupling arrangement is of course not limited to this, but can in principle be used with all motor vehicle locking devices, i.e. not necessarily with and in conjunction with motor vehicle locks. In any case, such internal actuating lever chains are always operated in such a way that, starting from a locked state of the motor vehicle locking device, force frequently has to be applied to an internal handle in two-stroke operation. In the first stroke, the relevant motor vehicle lock and in particular the vehicle door lock is unlocked. The second stroke of the actuating lever or the inner handle then causes the vehicle lock to be opened. In this way, unintentional door openings can be ruled out, which increases security. In principle, however, single-stroke actuations in the sense of a so-called “override function” are also generally possible in practice.

Motor vehicle locking devices of the described at the onset design are often and until now always used in conjunction with mechanically opening motor vehicle locks and motor vehicle door locks. In this case, unlocking and locking can be performed manually or by electric motor, wherein however the actual opening of a locking mechanism provided at the end of the actuating lever chain is always carried out manually or mechanically. Nowadays, however, electromotive solutions are increasingly favored for opening the locking mechanism. The reason for this is that such an electromotive opening is associated with reduced actuating forces and operating errors are also avoided. However, electromotive openings of vehicle locks are aimed at automatically unlocking and opening the relevant vehicle door from the outside. If, on the other hand, an internal actuation in the sense of a two-stroke operation is to be realized as before and as usual, convincing approaches to this are still lacking.

The procedure in the generic prior art according to DE 10 2020 113 992 A1 is such that the actuating lever can act on the release lever following the accumulator lever during its second stroke, and at the same time be returned to the home position by the stored mechanical energy. Although this reduces the design effort in comparison to the prior art, this does not provide a solution that can be combined with an electric motor drive.

The invention is based on the technical problem of further developing such a motor vehicle locking device in such a way that additional electromotive operation can be realized and implemented while retaining the basic operating philosophy.

To solve this technical problem, a generic motor vehicle locking device within the scope of the invention is characterized in that an electric motor drive is additionally provided, which optionally prevents or permits a subsequent movement of the release lever during the second stroke of the actuating lever.

In the context of the invention, the procedure therefore remains such that a two-stroke actuation is carried out. During its first stroke, the actuating lever ensures that this first stroke is or can be stored with the aid of the accumulator lever. This applies at least until the motor vehicle locking device is in its “unlocked” position. As a result of this, the accumulator lever is transferred to an associated storage position.

If the accumulator lever is in the said storage position, the release lever can follow the accumulator lever in the storage position during the second stroke of the actuating lever. This acts on the release lever for its part, and the movement of the release lever ensures that the closed locking mechanism provided at the end of the actuating lever chain realized in this way, and in particular the inner actuating lever chain, is opened. This is because when the locking mechanism is closed, the release lever generally ensures that the pawl is lifted from its engagement with the rotary latch. The rotary latch opens spring-assisted and releases a locking bolt. The associated motor vehicle lock and the motor vehicle door are open.

In this case, a subsequent movement of the release lever is therefore permitted during the second stroke of the actuating lever. The “unlocked” state of the electric motor drive and consequently also of the actuating lever chain or inner actuating lever chain realized in this way corresponds to this. The subsequent movement of the release lever is manifested in the fact that during and after the first stroke of the actuating lever, the accumulator lever assumes and can also assume and maintain its storage position, so that subsequently thereto during the second stroke of the actuating lever, the release lever follows the actuating lever or the accumulator lever that is in the storage position and is actuated with the aid of the actuating lever. As a result, the release lever can open the locking mechanism which was previously in its closed state. If the actuating lever reverses from this (usually spring-assisted), the storage position of the accumulator lever is automatically released so that the motor vehicle locking device is once again in its initial position after the motor vehicle locking device has resumed the rest position.

With the aid of the additional electric motor drive provided according to the invention, the described subsequent movement of the release lever can now optionally be prevented or permitted during the second stroke of the actuating lever. Allowing the subsequent movement of the release lever specifically means that the accumulator lever retains its storage position. However, if the electric motor drive ensures that the release lever cannot follow the second stroke of the actuating lever or that the subsequent movement is prevented, the electric motor drive ensures that the storage position of the accumulator lever is released.

To specifically implement and realize this, the electric motor drive usually operates on a latching element to realize a releasable storage position of the accumulator lever. This means that the previously mentioned storage position of the accumulator lever can be realized and canceled with the aid of the latching element. If the accumulator lever assumes its memory position, there is a latching connection between the latching element on the one hand and the accumulator lever on the other hand. To release the storage position, the aforementioned latching connection is interrupted. The electric motor drive optionally ensures this.

For this purpose, the electric motor drive is advantageously designed in at least two parts with an output element on the one hand and a control lever on the other, which can be actuated by the output element and interacts with the latching element. In other words, the output element is initially acted upon by the electric motor drive or an electric motor that is generally implemented at this point. In this case, the output element generally performs swivel movements. These swivel movements of the output element are in turn transmitted to the control lever that can be actuated by the output element. The control lever in turn interacts with the latching element and ensures that the latching element can or cannot lock with the accumulator lever to assume the storage position. The former variant corresponds to the fact that the electric motor drive allows the assumption of the storage position by the accumulator lever, and therefore also the subsequent movement of the release lever during the second stroke of the actuating lever. In this case, the electric motor drive is in its “unlocked” state.

If, on the other hand, the electric motor drive and then of course also the actuating lever chain realized in this way assumes its “locked” state, the electric motor drive has previously ensured, via the output element and the control lever, that the latching element is pivoted, and a latching connection between the accumulator lever and the latching element therefore does not occur. In this case, the subsequent movement of the release lever during the second stroke of the actuating lever is prevented by the electric motor drive. The “locked” state corresponds to this.

The control lever is advantageously a two-arm lever that can be rotated about an axis. One arm of the two-arm lever interacts with the output element described above as part of the electric motor drive. In contrast, the other second arm of the two-arm lever or control lever is designed as an extension arm that acts on the latching element. With the aid of this extension arm, the latching element, which can rotate about an axis, can therefore be pivoted to such an extent that when the accumulator lever is acted upon by the actuating lever, the accumulator lever cannot switch to its storage position because there is no latching connection to the latching element.

The actuating lever can advantageously be mounted on the same axis as the control lever. In this way, the control lever simultaneously provides a base and axis for the actuating lever. In principle, the actuating lever can be actuated manually or by a motor. In the latter case, an electromotive opening drive may correspond to this, which coincides or may coincide with the already existing electric motor drive.

The electric motor drive is generally connected to a control unit. The control unit actuates the electric motor drive, usually in accordance with at least one signal from a sensor. Usually, at least two sensors are connected to the control unit. The signals of the relevant sensors in question and evaluated by the control unit can be those of a door handle switch, a crash sensor, individually or in combination.

If the sensor is designed as a door handle switch, the control unit can be used to detect the actuation of an exterior door handle, for example, via the associated door handle switch. As a result of actuating the door handle switch, the control unit may ensure that the electric motor drive is actuated in order to ensure an electromotive opening of the motor vehicle locking device. For this purpose, the electric motor drive works directly or indirectly on the latch in the closed position and ensures that the pawl, which is in latching engagement with the rotary latch, is lifted from its engagement with the rotary latch. The rotary latch opens spring-assisted and releases a previously trapped locking bolt. The associated motor vehicle door and the motor vehicle door lock are opened.

Alternatively, if the control unit detects a signal from the crash sensor, the electric motor drive is activated in the sense of a “TCR; temporary crash redundancy”. In other words, in this case, the electric motor drive ensures that the motor vehicle locking device according to the invention switches to its “unlocked” state following the signal from the crash sensor. The functional position “TCR off” corresponds to this.

In this context, the invention is based on the realization that the motor vehicle locking device according to the invention generally assumes its “locked” (TCR On) functional position during operation of the motor vehicle in order to prevent unintentional openings of an associated motor vehicle door both from the inside and from the outside during operation of the motor vehicle. In the event of a crash and a signal from the crash sensor, the electric motor drive is then controlled and actuated via the control unit in such a way that it provides the “temporary crash redundancy” already mentioned above. Specifically, this means that the motor vehicle locking device, or the associated actuating lever chain is switched to its “unlocked” functional position (TCR Off).

As a result, the motor vehicle lock or motor vehicle door lock belonging to the motor vehicle locking device can be easily opened because the unlocked state that is then automatically assumed following the crash allows the locking mechanism to be opened. As a rule, a switching lever is provided in addition to the accumulator lever. The switching lever and the accumulator lever can be elastically coupled to each other via a spring. In addition, the design is usually such that the switching lever, the accumulator lever and the release lever are generally mounted axially aligned with each other and rotatable about the common axis.

If, for example, the actuating lever is actuated in the “unlocked” state of the motor vehicle locking device, the first stroke of the actuating lever causes the accumulator lever to assume its storage position. Since the switching lever and the accumulator lever are elastically coupled to each other via the spring, the switching lever follows the accumulator lever which is in its storage position. As a result, during the second stroke of the actuating lever, the actuating lever can act not only on the accumulator lever, but also on the switching lever, which then also comes into the sphere of influence of the actuating lever, which in turn entrains the release lever during this process. Accordingly, the release lever follows the accumulator lever during the second stroke of the operating lever. Since the accumulator lever, the switching lever and the release lever are generally mounted on the same axis as each other and rotatable about the common axis, the rotational movement of the release lever initiated thereby causes the locking mechanism, which was previously in the closed state, to open as desired. In other words, the motor vehicle door in question can be easily opened both from the outside and from the inside following the crash described, because following the crash the motor vehicle locking device has been transferred to its “unlocked” state, which allows the locking mechanism to be opened as described.

The same can also be configured and implemented, for example, in the event that for example an electrical power supply provided by a motor vehicle power supply device, such as an accumulator, drops to such an extent that for example subsequent operation of the electric motor drive is no longer guaranteed. In this case too, the performance of the electrical energy supply unit can be queried via a corresponding sensor or voltage sensor and transmitted to the control unit. If there is a risk of a significant drop in the electrical power supply, the control unit can again ensure that the motor vehicle locking device is transferred from its previously assumed “locked” state to the “unlocked” functional position in order to continue to ensure unchanged access to the motor vehicle interior.

Finally, there is the further possibility in this context that all motor vehicle locking devices or motor vehicle locks of a motor vehicle can be as it were synchronized in this way. That is, the individual electric motor drives of the associated motor vehicle locking devices corresponding to the respective motor vehicle doors can be controlled together via the control unit. In the event of a crash or an imminent failure of the motor vehicle battery, the control unit then ensures that all motor vehicle locking devices are synchronized from their “locked” state, for example during operation of the motor vehicle, to the “unlocked” state. All of this is achieved taking into account a structurally simple design. This is where the main advantages are evident.

In the following, the invention is explained in more detail with the aid of a drawing showing only one exemplary embodiment; in the figures:

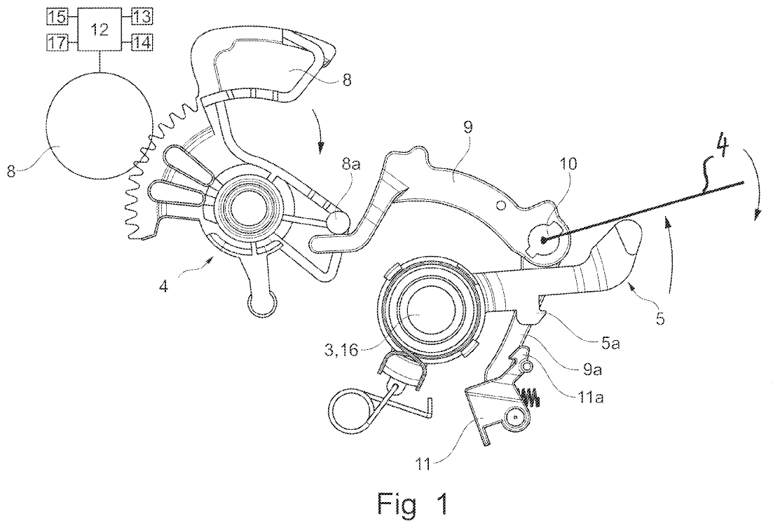

FIG. 1 to 7 show a front view of the motor vehicle locking device in various functional positions, and

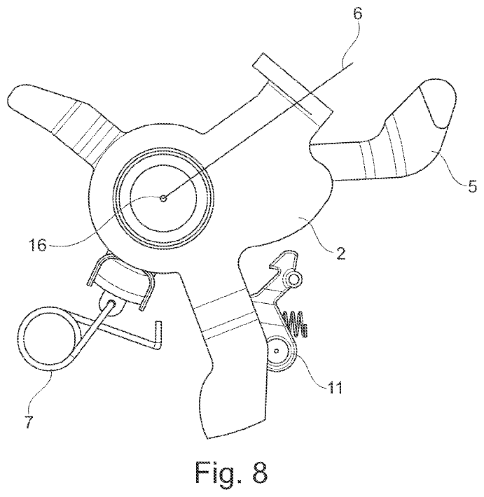

FIG. 8 to 13 show the relevant motor vehicle locking device in another view with different functional elements.

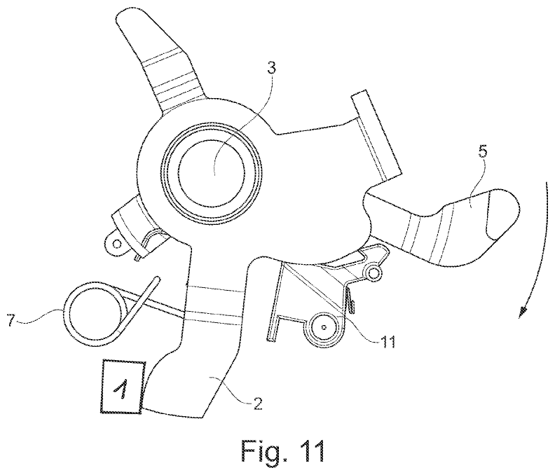

The figures show a motor vehicle locking device which, according to the exemplary embodiment example and not restrictively, is a component of a motor vehicle lock and, in particular, a motor vehicle door lock. For this purpose, the motor vehicle locking device has a locking mechanism 1, which is only indicated in FIG. 11 and substantially consists of a rotary latch and pawl. A release lever 2 shown therein acts on the catch 1 to open it, which is namely actuated about its axis 3 in the clockwise direction indicated in FIG. 11. The clockwise actuation of the release lever 2 about the axis 3 results in a pawl as a component of the locking mechanism 1 consisting of pawl and rotary latch being lifted from its latching engagement with the rotary latch. The rotary latch opens spring-assisted and releases a previously trapped locking bolt. The relevant motor vehicle lock as well as the associated motor vehicle door are opened. As mentioned, this requires a clockwise movement of the release lever 2 around the axis 3 corresponding to the representation in FIG. 11.

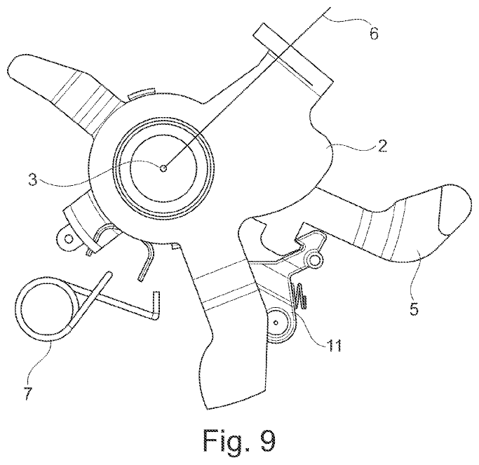

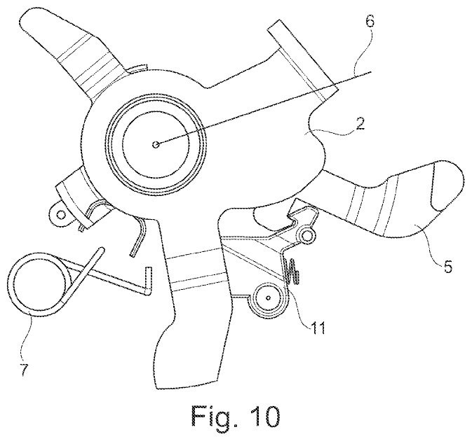

The further basic structure of the motor vehicle locking device also includes a coupling arrangement 2, 4, which is substantially composed of an actuating lever 4 and the release lever 2, which has already been mentioned and can be detachably coupled to the actuating lever 4. The actuating lever 4 and the release lever 2 can be coupled to each other or couplable to each other by a two-stroke actuation of the actuating lever 4, starting from an uncoupled basic position as shown in FIG. 1, for example. This coupled state between the actuating lever 4 and the release lever 2 is shown in FIG. 9 to 10 and then in the transition to FIG. 11.

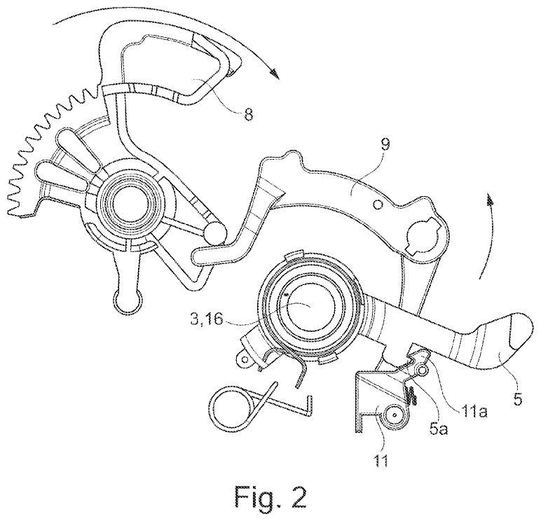

An accumulator lever 5 that stores the first stroke of the actuating lever 4 is also provided. With the aid of the first stroke of the actuating lever 4, the accumulator lever 5 can be transferred to a storage position, as it has assumed for example in FIG. 2 and becomes clear during the transition from FIG. 1 to FIG. 2. As a result of this, the actuating lever 4 can actuate the release lever 2 following the accumulator lever 5 during its second stroke. According to the exemplary embodiment, an additional switching lever 6 is realized for this purpose which is primarily reproduced schematically in FIG. 11 or in the preceding FIG. 8 to 10. It can be seen that the accumulator lever 5 and the switching lever 6 are elastically coupled to each other via a spring 7.

In addition and according to the invention, an electric motor drive 8, 9 is also realized. According to the exemplary embodiment, the electric motor drive 8, 9 is formed in at least two parts with an output disk or an output element 8 on the one hand and a control lever 9 on the other hand. The output element or output disk 8 can be set into rotation with the aid of an electric motor indicated in FIG. 1. As a result, the output element 8 is able to actuate the control lever 9. In fact, the control lever 9 can be pivoted about an axis 10 using the electric motor drive 8, 9. According to the exemplary embodiment and not restrictively, the actuating lever 4 is also rotatably mounted about the axis 10 so that the control lever 9 and the actuating lever 4 are each rotatably mounted on the same axis with respect to the common axis 10.

The control lever 9 is used to actuate a latching element 11 or can interact with the latching element 11 in question. The latching element 11 is in turn rotatably mounted about an axis. In addition, the latching element 11 has a latch 11a, which can latch with another latch 5a on the accumulator lever 5. However, this is only possible when the accumulator lever 5 assumes its storage position, as shown by way of example in FIG. 2. Here one can see that both latches 5a, 11a are in engagement with each other.

As already explained, the control lever 9 is rotatably mounted around the axis 10. In addition, the control lever 9 according to the exemplary embodiment is a two-arm lever. One lever arm of the control lever 9 is actuated by the output element 8. For this purpose, the output element 8 has a pin 8a which works on the lever arm of the control lever 9 facing the output element 8. In addition, the control lever 9 is equipped with an extension arm 9a which actuates the latching element 11. This can best be understood by comparing the sequence of FIGS. 1 and 2.

In fact, during the transition from FIG. 1 to FIG. 2, the control lever 9 pivots about its axis 10 in a counterclockwise direction. In order to bring about this counterclockwise movement of the control lever 9 starting from FIG. 1, the output element 8 moves around its axis starting from FIG. 1 in the clockwise direction indicated therein.

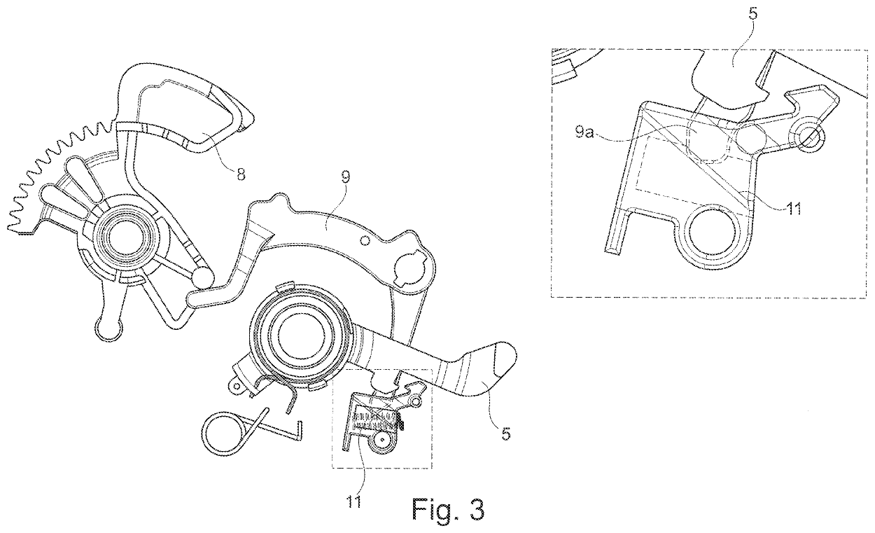

In any case, the counterclockwise movement of the control lever 9 during the transition from FIG. 1 to FIG. 2 causes the control lever 9 to move with its extension arm 9a against a pin on the rotatable latching element 11 so that the latching element 11 is pivoted clockwise starting from the functional position in FIG. 1. As a result of this, the latches 11a on the latching element 11 on the one hand and 5a on the accumulator lever 5 on the other hand can no longer engage with each other during the transition from FIG. 1 to FIG. 2 and further to FIG. 3.

Of particular importance is also a control unit 12 which, according to the exemplary embodiment, queries and evaluates the signals of a plurality of sensors 13, 14, 15, 17. According to the exemplary embodiment and not restrictively, the sensor 13 is a door handle switch, which is arranged on an outside door handle or inside door handle and senses its actuation. The sensor 14 is designed as a crash sensor and responds in the event of a crash. Finally, sensor 15 is such a sensor or voltage sensor 15 that measures the voltage at a motor vehicle power supply unit, in particular an accumulator. With the aid of the sensor 15 or voltage sensor, an undervoltage or insufficient electrical power supply for operating the electric motor drive 8, 9, for example, can be determined.

The mode of operation is as follows. In FIG. 1, the motor vehicle locking device is in its resting or initial state. The transition from FIG. 1 to FIG. 2 shows that, on the one hand, the actuating lever 4 is actuated clockwise about its axis 10 and, on the other hand, the electric motor drive 8, 9 is actuated with the aid of the control unit 12. The clockwise actuation of the actuating lever 4 about its axis 10 results in the accumulator lever 5 being pivoted clockwise about its axis 16 starting from the functional position in FIG. 1 during the transition from FIG. 1 to FIG. 2. In fact, the accumulator lever 5 has its own axis 16 for its rotation, which, according to the example, coincides with the axis 3 of the release lever 2.

Since the electric motor drive 8, 9 was not actuated during the transition from FIG. 1 to FIG. 2 or the motor vehicle locking device still assumes its “unlocked” state, the latches 11a on the latching element 11 on the one hand and on the accumulator lever 5 on the other hand can engage with each other. As a result, starting from the functional position in FIG. 1, the accumulator lever 5 assumes its storage position in the transition to FIG. 2 shown therein.

Typically, during operation of the motor vehicle, the speed of the motor vehicle is detected and evaluated by another sensor 17, which is also interrogated with the aid of the control unit 12. As soon as the speed of the motor vehicle exceeds a predefined speed such as walking speed, for example, the control unit 12 ensures that the electric motor drive 8, 9 is actuated in such a way that the motor vehicle locking device transitions into its “locked” position. The “TOR On” process corresponds to this, as can be seen in the transition from FIG. 1 to FIG. 2 and on to FIG. 3. This means that the assumption of the “locked” position is implemented and realized in that the electric motor drive 8, 9 ensures that the control lever 9 is increasingly pivoted counterclockwise around its axis 10 during the transition from FIG. 1 to FIG. 2. For this purpose, the output element 8 is moved clockwise around its axis with the aid of the electric motor and actuated by the control unit 12.

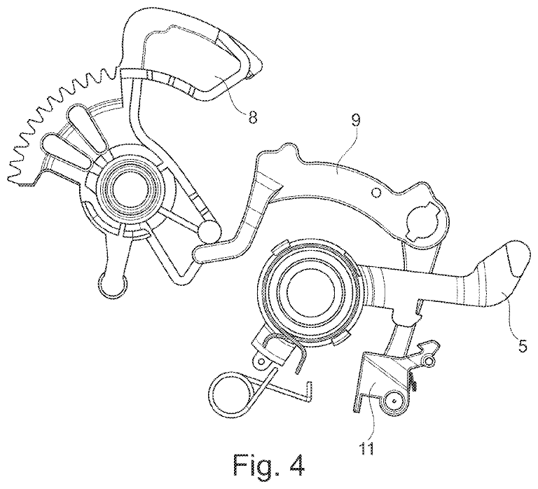

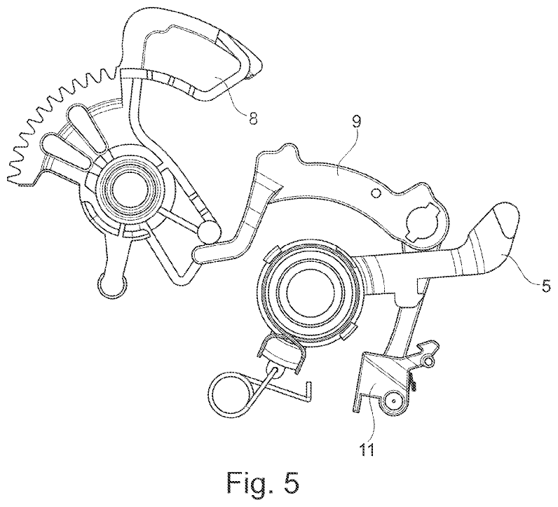

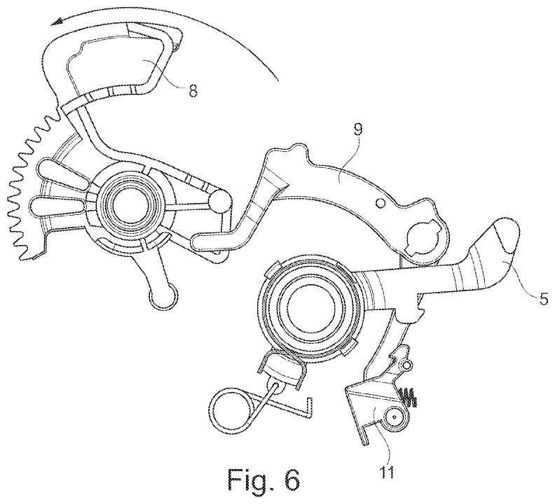

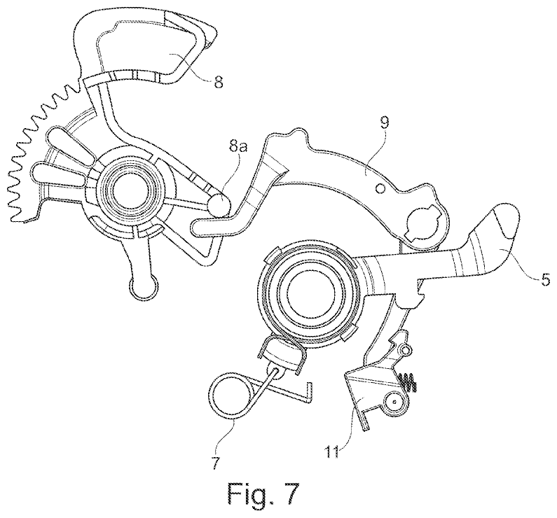

The counterclockwise movement of the control lever 9 about its axis 10 results in the latching element 11 being increasingly pivoted about its axis via the extension arm 9a on the control lever 9, namely clockwise during the transition from FIG. 1 to FIG. 2 and on to FIG. 3. As a result, the latches 11a on the latching element 11 and 5a on the accumulator lever 5 can no longer latch together, as can be seen from the functional position in FIG. 3. In other words, the latching element 11 is open in the illustration according to FIG. 3, and the storage position of the accumulator lever 5 previously assumed in FIG. 2 is canceled. The motor vehicle locking device is in the “locked” state. Since the accumulator lever 5 has been released from the latching element 11 during the described process, the accumulator lever 5 moves counterclockwise around its axis 16 during the transition from FIG. 3 to FIG. 4. A spring may be responsible for this. As a result of this, the accumulator lever 5 assumes its rest position during the transition from FIG. 4 to FIG. 5. During the further transition from FIG. 5 to FIG. 6, the electric motor drive 8, 9 is actuated in the sense of “TOR OFF” or “unlocked”. This corresponds to a counterclockwise movement of the output element 8 during the transition from FIG. 5 to FIG. 6. In FIG. 7, the rest position of the system is reached in which the electric motor drive 8, 9 has been reset, namely in such a way that the pin 8a of the output element 8 is in contact with the associated arm of the control lever 9.

FIG. 8 to 13 now show the relevant motor vehicle locking device in a different representation in a comparable functional sequence. Here, FIG. 8 corresponds to the rest position of the motor vehicle locking device according to FIG. 1. If, starting from this rest position according to FIG. 1 or FIG. 8, the actuating lever 4 is pivoted clockwise about its axis 10, the actuating lever 4 operates on the accumulator lever 5 in such a way that the accumulator lever 5 is pivoted clockwise about its axis 16 during the transition from FIG. 8 to FIG. 9, and the corresponding latches 11a on the latching element 11 and 5a on the accumulator lever 5 come into engagement with each other, as shown in FIGS. 2 and 9. The accumulator lever 9 is now in its storage position. In this storage position according to FIG. 9 and in the transition to FIG. 10, the switching lever 6 elastically coupled to the accumulator lever 5 consequently follows the accumulator lever 5. As a result, during the transition from FIG. 8 to FIG. 9 and on to FIG. 10, the switching lever 6 performs a swiveling movement around the common axis 16, namely clockwise. In fact, the accumulator lever 5, the switching lever 6 and the release lever 2 are each mounted so that they can rotate on the same axis in relation to the common axis 16. Because the switching lever 6 follows the accumulator lever 5 in its storage position, the switching lever 6 moves clockwise around the axis 16, and the contours on the switching lever 6 on the one hand, and on the release lever 2 on the other hand, come into mutual contact (see FIG. 10).

If, starting from the functional position in FIG. 10, the actuating lever 4 is now actuated again clockwise around its axis 10 during a second stroke, during the transition from FIG. 10 to FIG. 11, this results in the release lever 2 being entrained in the process with the clockwise movement of the actuating lever 4. In other words, during the second stroke of the actuating lever 4, the release lever 2 follows the accumulator lever 5, and can also follow the accumulator lever 5 because the as it were interposed switching lever 6 ensures a mechanical coupling as described. The clockwise movement of the release lever 2 now has the effect that the locking mechanism 1 present at the end of the actuating lever chain and shown in FIG. 11 is thereby actuated, and namely by the release lever 2 rotating clockwise about the common axis 16. The release lever 2 thereby ensures, as described, that the locking pawl is lifted from its latching engagement with the rotary latch, and the motor vehicle lock and the associated motor vehicle door are opened.

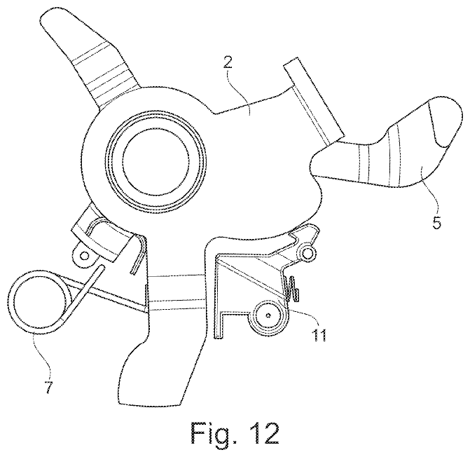

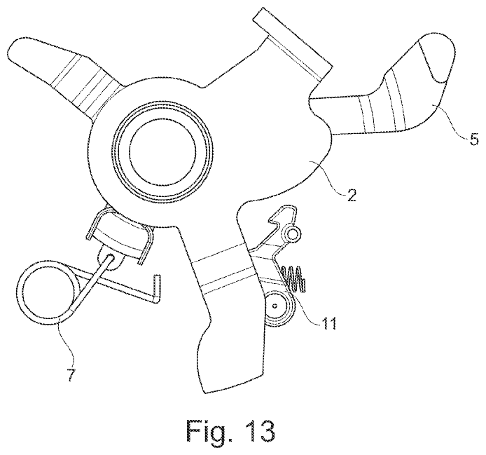

At the same time, the transition from FIG. 10 to FIG. 11 ensures that the latching connection between the two latches 5a and 11a is released so that, during the reversing movement starting from FIG. 11 of the accumulator lever 5 during the transition to FIG. 12 and finally to FIG. 13, the accumulator lever 5 is free of the latching element 11. As a result of this, the motor vehicle locking device in FIG. 13 is once again in its rest position, as shown in FIGS. 1 and 8. The release of the connection between the two latches 5a, 11a can be supported by the release lever 2 actuating the switching lever 6 and thus on the accumulator lever 5 via a contour.

It can be seen that the motor vehicle locking device assumes its “locked” position initially and during operation of the motor vehicle, as is ultimately shown in FIG. 3. If, following a first stroke of the actuating lever 4 in the functional position according to FIG. 3, the accumulator lever 5 is actuated with a second stroke with the aid of the actuating lever 4, the locking mechanism 1 cannot be opened. This is because actuating the operating lever 4 in the functional position, for example according to FIG. 3, leads to the fact that in the process, the release lever 2 is not entrained, and also cannot be entrained because the accumulator lever 5 is not in its storage position, as it is shown in FIGS. 2 and 9, 10. As a result, in this case and in the “locked” state, the release lever 2 cannot follow the actuating lever 4 in its second stroke, as little as it can follow the accumulator lever 5, and this results in the described and desired empty movement in relation to the locking mechanism 1 in the “locked” state.

In the event of a crash or when the electrical voltage of the motor vehicle's power source drops, the electric motor drive 8, 9 then ensures that the motor vehicle locking device changes from its previously assumed “locked” state to the “unlocked” functional state. This corresponds to the fact that the electric motor drive 8, 9 is actuated as can be seen in the transition from FIG. 5 to FIG. 6 and on to FIG. 7. This includes a counterclockwise movement of the output element 8, which causes the control lever 9 to pivot clockwise about its axis 10, and consequently, the latching element 11 is not (no longer) acted upon. As a result of this, an actuation of the actuating lever 4 or a first stroke causes the accumulator lever 5 to transition to its storage position, as shown in FIGS. 2 and 9, 10. This is because the two latches 5a, 11a can now engage with each other, and the accumulator lever 5 is held in its storage position.

As a result, the switching lever 6 follows the accumulator lever 5 via the interposed spring 7, and the above described mechanical coupling occurs between the shift lever 6 on the one hand and the release lever 2 on the other. This is substantially shown in FIG. 10.

If, starting from this functional position in FIG. 10, the actuating lever 4 then works on the accumulator lever 5 or the switching lever 6 and actuates them clockwise around their common axis 16, the release lever 2 mounted on the same axis is entrained and can open the locking mechanism 1 as described. As a result, the above described “temporary crash redundancy” is realized. In other words, in the event of a crash, the actuating lever chain equipped with 10 the motor vehicle locking device according to the invention is transferred to its “unlocked” state so that the locking mechanism 1 can, subsequent thereto, be (manually) opened by the described two-stroke actuation.

### REFERENCE NUMBER LIST

Locking mechanism 1
Release lever 2
Axis 3
Actuating lever 4
Accumulator lever 5
Latch 5a
Switching lever 6
Spring 7
Drive 8, 9
Pin 8a
Axis 10
Latching element 11
Latch 11a
Control unit 1
Sensors 13, 14, 15, 17
Axis 16

1. A motor vehicle locking device comprising:
a coupling arrangement including an actuating lever and a release lever that can be is couplable releasably to the actuating lever, wherein the actuating lever and the release lever are be coupled to one another starting from an uncoupled basic position to a coupled position by a two-stroke actuation of the actuating lever,
an accumulator lever which stores a first stroke of the two-stroke actuation of the actuating lever so that, during a second stroke of the two-stroke actuation of the actuating lever, the actuating lever acts on the release lever after the accumulator lever, and
an electric motor drive which selectively prevents or permits a subsequent movement of the release lever during the second stroke of the actuating lever.

2. The locking device according to claim 1, further comprising a latching element, wherein the electric motor drive operates on a latching element to realize a releasable storage position of the accumulator lever.

3. The locking device according to claim 2, wherein the electric motor drive has at least two parts including an output element, and a control lever which is be actuated by the output element and which interacts with the latching element.

4. The locking device according to claim 13, wherein the control lever is a two-arm lever rotatable about an axis.

5. The locking device according to claim 3, wherein the control lever has an extension arm actuating the latching element.

6. The locking device according to claim 13, wherein the actuating lever is mounted on a same axis as the control lever.

7. The locking device according to claim 1, further comprising a control unit and at least one sensor, wherein the electric motor drive is connected to the control unit which actuates the electric motor drive in accordance with at least one signal from the at least one sensor.

8. The locking device according to claim 7, wherein the at least one sensor comprises a door handle switch, crash sensor, or a voltage sensor, individually or in combination.

9. The locking device according to claim 1, further comprising a switching lever and a spring, wherein the switching lever and the accumulator lever are coupled to one another via the spring.

10. The locking device according to claim 9, wherein the switching lever, the accumulator lever and the release lever are mounted axially aligned with one another and are rotatable about a common axis.

11. The locking device according to claim 4, wherein the two-arm control lever includes a first arm that is acted upon by the output element and a second arm that acts on the latching element.

12. The locking device according to claim 11, wherein output element has a pin that acts on the first arm, and the second arm has an extension that acts on the latching element.

13. The locking device according to claim 1, wherein when the actuating lever is actuated in an unlocked state of the motor vehicle locking device, the first stroke of the actuating lever causes the accumulator lever to assume a storage position and during the second stroke of the actuating lever the actuating lever can act not only on the accumulator lever.

14. The locking device according to claim 13, wherein during a locked state of the motor vehicle locking device, the release lever cannot follow the actuating lever during the second stroke.

15. The locking device according to claim 2, wherein the latching element has a first latch that interacts with a second latch located on the accumulator lever when the accumulator lever is in the storage position.
